(19) United States
(12) Patent Application Publication
(10) Pub. No.: US 2018/0130019 A1
(43) Pub. Date: May 10, 2018

(54) System and method for Managing user and project nodes in a graph database

(71) Applicants: Kurt Robert KOLB, Burnaby (CA); Maziyar HAMDI, Vancouver (CA)

(72) Inventors: Kurt Robert KOLB, Burnaby (CA); Maziyar HAMDI, Vancouver (CA)

(73) Assignee: 0934781 B.C. Ltd, Vancouver (CA)

(21) Appl. No.: 15/629,707

(22) Filed: Jun. 21, 2017

Related U.S. Application Data
(60) Provisional application No. 62/352,989, filed on Jun. 21, 2016.

(51) Int. Cl. G06Q 10/10; G06F 17/30

(52) U.S. Cl. CPC G06Q 10/10; G06F 17/30958; G06N 99/005; G06F 17/3053; G06F 17/30867; G06F 17/30477

(57) ABSTRACT

A computer-implemented method and system are provided for connecting nodes, such as projects, users, and organizations in a database. A computer processes the connections to recommend further connections to objects, group objects that are related, and provide search results.

### BACKGROUND

Currently online resources are used by people to search and compare companies, with respect to such things as providing services. The resource may be a website providing a search engine or directory, which tries to match companies to searched attributes or keywords. Such websites are not inherently interactive for providing social discovery, learning or personalization.

Professional Social Networks such as LinkedIN and Viadeo record personal connections but are not arranged to make use B2B relationships or make informed search and recommendations.

Moreover directories, social networks, and company databases currently store data about companies and people using self-described terms regarding quality and expertise. Thus the data are neither easy to verify nor quantify when comparing companies.

### DRAWINGS

FIG. 1 is an illustration of software modules operating in a server or client device.

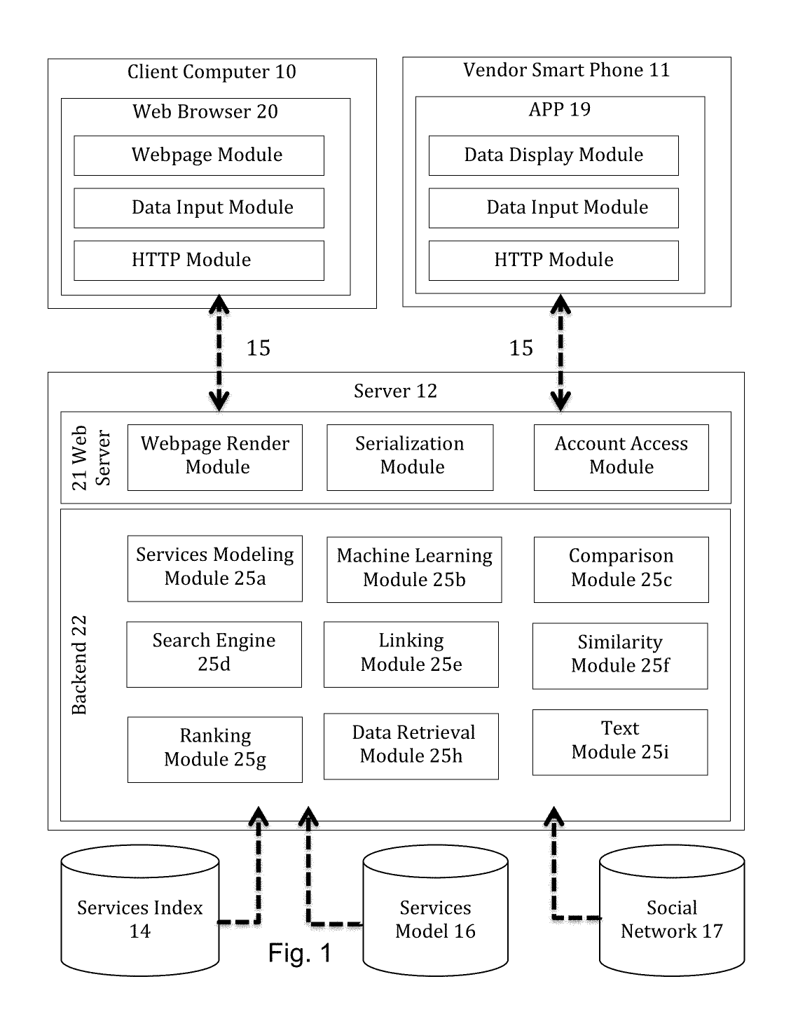

FIG. 2 is a graph of interconnected projects, employees and organizations.

FIG. 3 is a graph illustrating how features are aggregated towards an organization.

FIG. 4 illustrates a Linking Module and Services Model for grouping projects.

FIG. 5 is an illustration of extracting and comparing two case projects.

FIG. 6 is a diagram of communication between a server and client devices.

FIG. 7 is a diagram of a computing system.

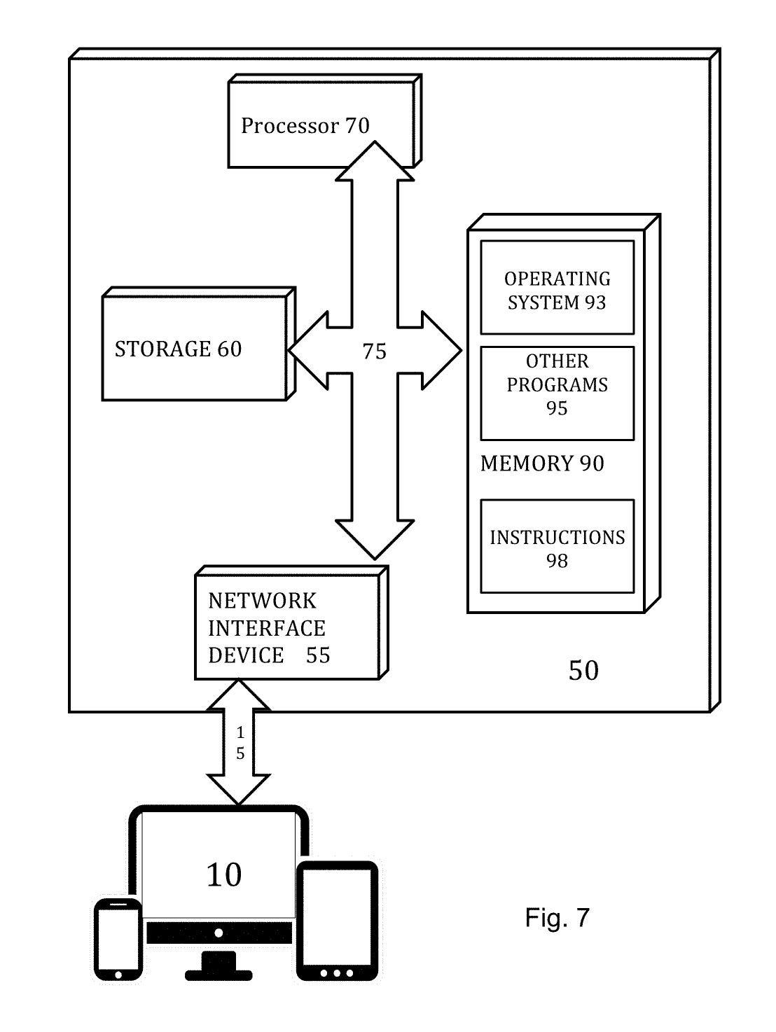

FIG. 8 is a data structure for a graph.

FIG. 9 is a data structure implemented with lists.

FIG. 10 is a web page of search results with related objects.

FIG. 11 is a flowchart for traversing a graph to predict users that contributed to a project.

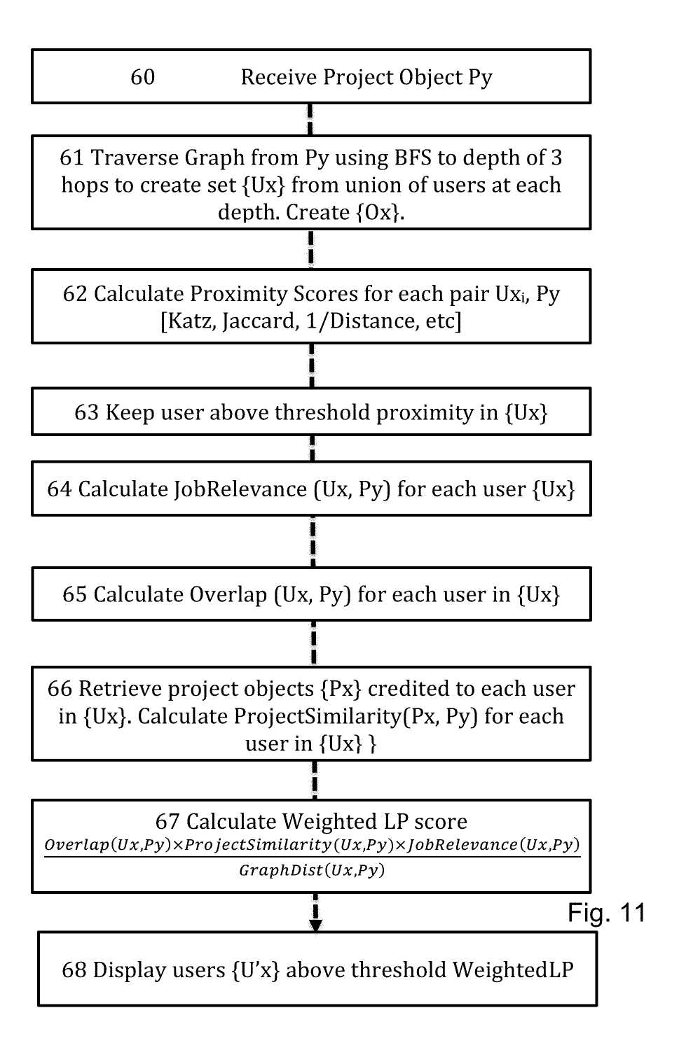

FIG. 12 is sample of a graph of related projects, users, and organizations.

FIG. 13 is a flow chart for identifying users that are both employees of a given organization and credited with working on a project liked by a user

### SUMMARY OF THE INVENTION

The present system introduces user and project nodes, means to find connections there between and data structures for facilitating efficient search and storage. These nodes provide more verifiable and quantifiable data for evaluating capabilities of organizations and increase the average number of paths from a given user to the organizations.

In accordance with a first aspect of the invention there is provided a computer-implemented method for operating on a graph database having organization nodes and project nodes. The method comprises: for each of a plurality of organization nodes in the database; traversing the graph to identify project nodes connected to that organization node; retrieving project features for the identified project nodes; aggregating the project features to create a set of organization features for that organization; and in response to a search query comprising search features, returning organization nodes having organization features that match the search features.

The method may provide a service model to map organization features to service features and calculate a confidence score for each service feature so mapped.

The project node may comprise text and tags that describe a past project done by the organization connected thereto in the graph and may relates to a real-world award, a case study, news article, or sample work.

The service features may comprise n-grams and tags describing professional services and capabilities.

The method may create the service model using machine learning, trained on a set of project nodes tagged with service features.

The method may apply a decay factor to project features, using dates of the respective project node, to calculate the aggregated organization features.

The organization features may be aggregated using the union of the project features.

The method may, for each organization node, calculate strength values for the organization features based on the frequency of project features in the project nodes.

In accordance with a second aspect of the invention there is provided a computer-implemented method for operating on a graph database having organization nodes and user nodes, the method comprising: for each of a plurality of organization nodes in the database; traversing the graph to identify user nodes connected to that organization node by an employment edge; retrieving user features for the identified user nodes; aggregating the user features to create a set of organization features for that organization; and in response to a search query comprising search features, returning organization nodes having organization features that match the search features.

The method may provide a service model to map organization or user features to service features and calculate a confidence score for each service feature so mapped.

The method may create the service model using machine learning, trained on a set of user nodes tagged with service features.

The user node may comprise text and tags that describe a skills, education, and jobs of the respective user.

The organization features may be aggregated using the union of the user features.

The method may, for each organization node, calculate the strength values for each of the organization features based on the frequency of user features in the user nodes.

The method may re-aggregate organization features for a particular organization node, when an employment edge is removed or added between a particular user node and that organization node.

In accordance with a third aspect of the invention there is provided a computer-implemented method for operating on a graph database having organization nodes and project nodes. The method comprises: providing a user interface for users to view and select project nodes; receiving a search query; identifying organization nodes that satisfy the search query; traversing the graph to identify user-selected project nodes connected by an edge to the identified organization nodes; and ranking the organization nodes at least partly based on the number of user-selected project nodes connected thereto.

In accordance with a fourth aspect of the invention there is provided a computer-implemented method for operating on a graph database having organization nodes and user nodes. The method comprises: providing a user interface for users to view and select user nodes; receiving a search query; identifying organization nodes that satisfy the search query; traversing the graph to identify user-selected user nodes connected by an edge to the identified organization nodes; and ranking the organization nodes at least partly based on the number of user-selected user nodes connected thereto.

The method may output ranked organization nodes in conjunction with their respective user-selected user nodes and project nodes.

In accordance with a fifth aspect of the invention there is provided a computer-implemented method comprising providing a graph database comprising interconnected nodes representing vendors, projects performed by the vendors and employees of the vendors; a web server providing a user-interface to enable a user to save projects and employees; the web server receiving a search query for vendors from the buyer-user; a processor identifying a plurality of vendors from the database that satisfy the search query; the processor identifying projects or employees connected to at least one of the identified vendors and saved by the buyer-user; the processor ranking the identified vendors based on the saved projects or employees connected to the identified vendors; and the web server communicating a subset of the identified, ranked vendors to the buyer-user as search results.

The method may further comprise the web server communicating a representation of some of the saved projects or employees together with the connected identified, ranked vendors.

In accordance with a sixth aspect of the invention there is provided a computer-implemented method comprising: providing a graph database having project nodes representing real-world projects and organization nodes representing real-world organizations; a processor receiving separate requests from a first and second users to connect first and second organization nodes to an identified project node; and creating an edge between the first and second organization in the database.

The method may determine and add tags to the created edge based on features extracted from the project node.

The method may calculate a verification score for the edge between the first and second organizations, wherein the verification score increases as more project nodes are mutually connected to the first and second organizations.

In accordance with a seventh aspect of the invention there is provided a computer-implemented method for discovering content items in a graph comprising: providing a graph database of content items and organizations; communicating a plurality of the content items to a user; receiving a user-selection of one or more of the content items; recording a connection between the user and selected content items in the database; identifying from the database organizations that are connected to the user-selected content items; and displaying some of the organizations to the user.

The method may use collaborative filtering to recommend further content items to the user based on the content items saved by the user and saved by other users.

The method may communicate a set of organizations as search results, which organizations satisfy a search query of the user and are connected to one or more of the content items saved by the user.

In accordance with an eighth aspect of the invention there is provided a computer-implemented method of grouping content items comprising: providing a database of project nodes, which objects comprise text or images representing a project; a processor identifying a set of candidate projects to compare; the processor performing feature extraction from the text or images of candidate projects; the processor comparing features of the candidate projects to calculate a likelihood that two or more candidate projects relate to the same project; and the processor connecting related project nodes in the database.

The set of candidate projects may be identified from project nodes connected to a same organization node.

The set of candidate projects are identified by clustering or classifying a plurality of project nodes and selecting the set of candidate projects from a cluster or class.

In accordance with a ninth aspect of the invention there is provided a computer-implemented method operating on a database representing a graph of project and user nodes connected by edges. The method comprises: identifying a project node to evaluate; traversing the graph from the project node to identity a first set of user nodes; calculating a graph proximity score for each user node with respect to the project node; selecting a subset of users from the first set of users based at least partly on their respective graph proximity scores; seeking user-confirmation, via a client-computing device, that one or more of the subset of users contributed to the project; and creating an edge from the project node to user nodes for users that are confirmed to have worked on the project.

The method may exclude, from the first set or subset of user nodes, user nodes that are directly connected to the project node by an edge.

The method may exclude, from the first set or subset of user nodes, user nodes that are further than a threshold proximity from the project node.

The step of traversing the graph may be limited to a threshold number of hops from the project node.

The graph may comprise a) organization nodes connected by employment edges to user nodes, representing a user employed at an organization and b) project nodes connected to organization and user nodes by credit edges, representing credit for working on the project.

Selecting a subset of users from the first set of users may be based on respective project similarity scores, which score is calculated for each user node in the first set by: identifying one or more second project nodes connected to that user node; extracting features of the project node and of the second project node; and calculating the similarity score from the project and second project features;

The subset of users may be further selected based on a date overlap score, which score is calculated based on the overlap in time between a) a given user's employment period at an organization which is connected to the project node and b) a date range comprised in the project node.

The subset of users may be further selected based on a skill-matching score, which score is calculated for each user in the first set by: extracting professional features in the professional profile of that user node; and comparing the professional features to project features of the project node.

In accordance with a tenth aspect of the invention there is provided a computer-implemented method operating on a database representing a graph of project and organization nodes connected by edges, the method comprising: identifying a project node to evaluate; traversing the graph from the project node to identity a first set of organization nodes; calculating a graph proximity score for each organization node with respect to the project node; selecting a subset of organization nodes from the first set based at least partly on their respective graph proximity scores; seeking user-confirmation, via a client-computing device, that one or more of the subset of organizations contributed to the project; and creating an edge from the project node to organization nodes for organizations that are confirmed to have worked on the project.

Advantageously the structure enables the system to provide the most relevant path from a user to the sought object via objects that are calculated to be highly relevant. These intermediate objects provide highly granular evidence of capabilities, which are also portable to other objects.

### DESCRIPTION

The present system comprises a database, representing a graph of nodes corresponding to people, projects, and organizations stored with a variety of connections there between. The system uses the connections to make recommendations, search objects, facilitate user-discover of objects, rank vendors, and group objects.

### Database Structure

The database structure may take many forms, depending on which is most efficient for data storage, retrieval and manipulation. The mathematical representation may be a graph, which is implemented with indices and lists of the primary data structure to improve certain retrieval and manipulation operations. The database implementation may be a relational database or a data store.

Data connections between organizations indicates that some real-world relationship exists for the provision of goods/services from a vendor organization to a client organization. Database connections between people may indicate “coworkers,” “friendship,” or “following”. Database connections between people and organizations may indicate “employment” or “following.” Database connections between projects and people/organizations may indicate “administrator”, “author”, “credit” or “following.” The nature and use of these records and connections are discussed in more detail below.

In formal terms, the graph

G={Vertices V, edges E}

V={organizations O, projects P, users U}

E={like, employ, follow, credit, admin, client-of, author} and their inverse edges.

The names of these connections are merely conventional and may be implemented using different names. Herein the names are intended to explain the connection reason and type, whereby edges are treated according to their type in the algorithms and rules. In the below discussion and accompanying figures, the names of edges and nodes are used as follows:

Credit edge: the connected user or organization claims credit for making some contribution to the connected project.

Like edge: a user records interest in an object, potentially for monitoring updates or discovering more objects connected to the ‘liked’ object.

Employ edge: a user is a current or past employee of an organization.

Author edge: connects a user node to a project node they created.

Admin edge: indicates that a user has administrative rights with respect to another node, such as a project or organization.

Vendor_to edge: a directed connection between organizations to indicate which organization is a service provider to the other. Inversely-client_of

User: A node representing a person having access rights to the system. A user node may comprise a profile text description and attribute data such as name, location, services provided, experience, educations, and skills.

Organization: A node representing a company, institution, government body, or charity. Organization nodes may include attributes such as name, location, industry, size, or products/services provided. An organization is accessed by an admin user.

Vendor: A user or organization that provides services.

Buyer: A user or organization that is searching for services.

Client: A user or organization that receives services (currently or previously).

Project: Passive nodes that describe or visualize a project, particularly for a past project. The node may comprise images, videos, text description, case studies, documents, links to external content, and awards.

Nodes in the system can be defined as active or passive, whereby active nodes can create new nodes or connect to existing nodes. Conversely passive nodes cannot create or connect to nodes themselves, although the system's algorithms may connect two passive nodes. Active nodes are people and organizations that are controlled by users. Passive nodes may be content items such as case studies, images, or articles and may be owned or created by a user. Thus, active nodes may elect to create, connect to, share, or follow passive nodes but not vice versa.

Sets of nodes have their own real-world meaning having useful search and discovery methods. For example, a set of users may represent a team. A set of projects may represent a mood board. A set of organizations may represent competitors.

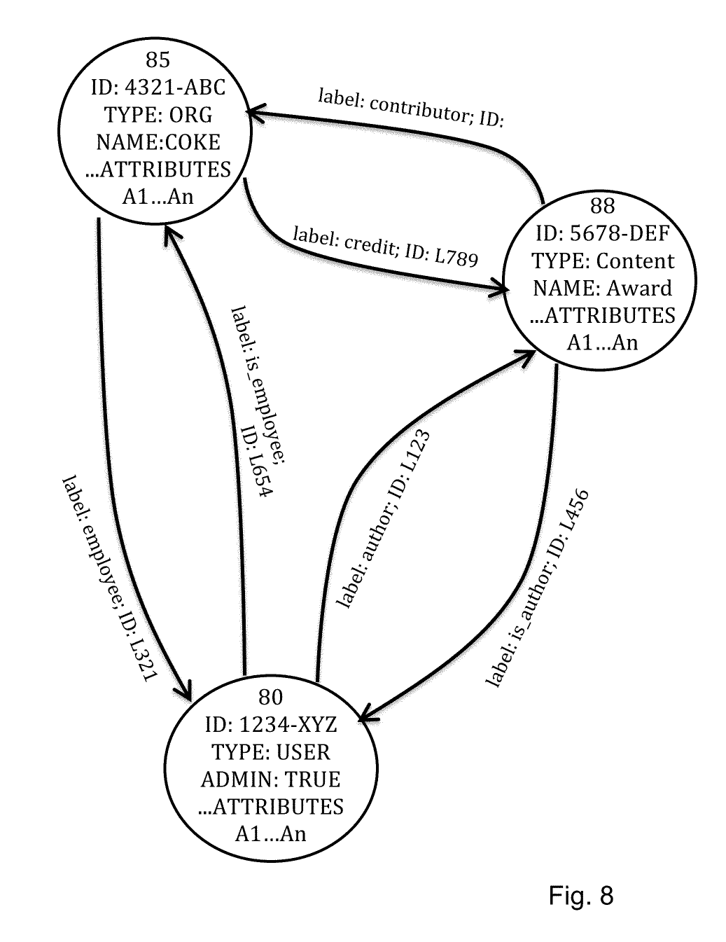

FIG. 8 illustrates a graph with connections between the three types of nodes: organizations 85, users 80, and content 88. Each node is characterized by a unique ID code, a node type, and attributes pertinent to the node type. In this example, each node type is connected to another node type with two reciprocal edges. Each edge has a unique ID code, edge type and the ID codes of the connected nodes. The edge may comprise attributes pertinent to that edge. The reciprocal edges enable the system to traverse the graph in either direction, e.g. determining a) all projects that a user contributes to or b) all contributors to a project. There may be several edges between the same two nodes to record different information about their relationship.

### Creating Project Nodes

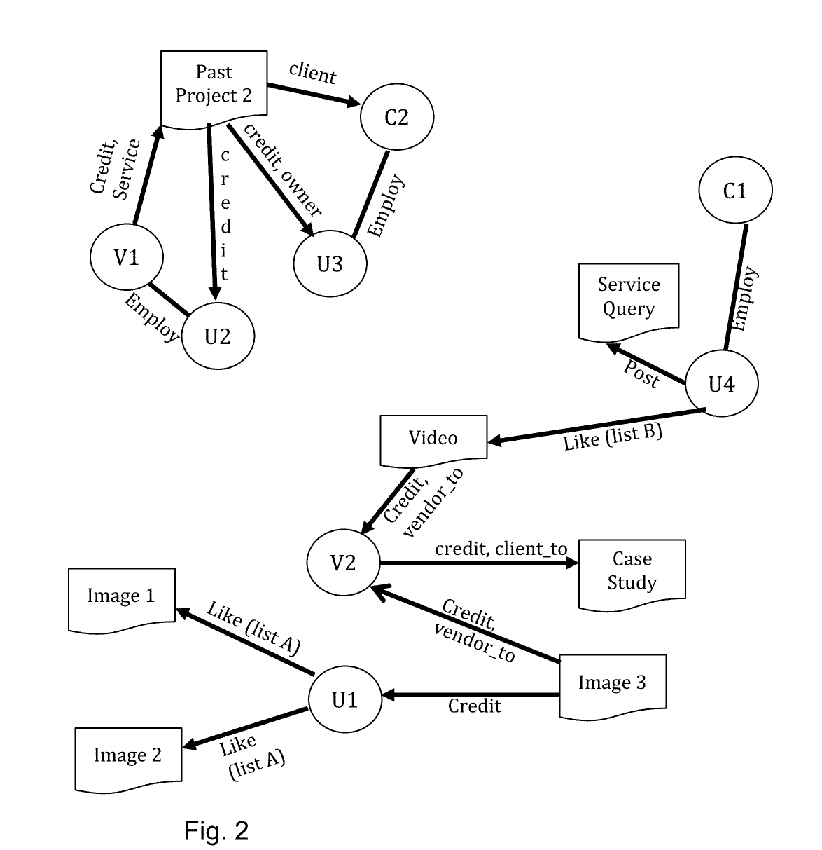

One aim of the network is to create project nodes that can be accessed by multiple users in order to grow connectivity in the graph. Consider the example of creating a node that describes a past project between organizations or users. A first user may author the text about the project and enter it into the system but give administrative rights to a second user. A third user could read the project on the network, claim credit for an aspect of the project, which can be accepted/rejected by the administrator user. A fourth user could collect the project into their list of interesting projects, which list is then shared with a fifth user via the network. In FIG. 2, employee U3, employed by Client Organization C2 adds a past project node 2. User U2, employed by Vendor Organization V1, claims credit too. U3 has administrator rights and connects C2 to the project node as a client. A credit connection is made for V1 too.

This project is recorded by the system in a database as a project node with its connections to user and organization nodes. The project node is passive but may find interaction through users and the system itself (for example, pushing recommendations of the content to users).

Advantageously, each project node added has the potential to gather other users and connections, hugely increasing the connectivity of the social network. Thus two users who do not know each other, become indirectly connected via a project node, which information is used in subsequent search.

### Combining Related Project Nodes

In contrast to certain social networks where users are expected to have unique opinions and experiences, an advantage of the present system is that stronger, more consistent information becomes available as nodes about the same project are grouped, such that more users gravitating towards the project as a group. In the present system, multiple users may create project nodes that are effectively duplicates or they may disagree about the purpose or result of a project. Moreover, some users may want to make minor edits or additions to an existing representation of the project. The project may have taken several years to complete, with many sub-projects completed by different users/organizations at different points in time. The present system includes modules for mediating duplication and disagreement.

A Linking Module compares project nodes to determine whether they are related or whether they belong to a super-project. If so, the nodes of the projects are linked in the database, either to each other or to a mutual super-project node. This may be done offline as a background operation or in real-time as users enter new project documents, in which case the user can select from a set of proposed related projects.

To increase efficiency, the Linking Module does not directly compare every project to every other project. Instead the Module preferably traverses the graph to identify for project nodes connected to a common user or common organization to determine candidate projects for comparison, as these are most likely to be similar. In an alternative approach, the Module compares projects having similar timelines (year, data, start date, or end date).

The Linking Module may also use unsupervised machine learning to cluster or classify the corpus of projects using techniques such as Neural Nets, Topic Modeling, k-nearest neighbor or Support Vector Machines. In this case, the Module identifies a set of projects that are in a cluster, class or are sufficiently similar to each other for further comparison.

These candidate projects may be sent to a user as a suggestion that the user accepts or rejects them as related. This step may be repeated for multiple users to crowd-source the ‘truth’ of the relatedness. Using an automated approach, the Linking Module calculates a likelihood of relatedness that a project node relates to another project or to a super-project and may automatically link project nodes.

The Module extracts project features from the project node depending on the format of the data, such as a text document or image. A comparison between documents is done based on similarity in features (words, n-grams, named-entities), using keyword-based or topic-based document similarity techniques such as Term Frequency-Inverse Document Frequency (TF-IDF) or Latent Direchlet Allocation (LDA). Image files may represent a project as a sample work, design, logo, advert, prototype, or product picture. Pre-processing of an image is done to extract features of identifiable objects or their properties. Third-party resources exist (such as Google's Cloud Vision API) for categorizing or tagging aspects of the image. Project nodes may also be tagged with features and/or comprise values for attribute types such as location, client name, project name, or timeline.

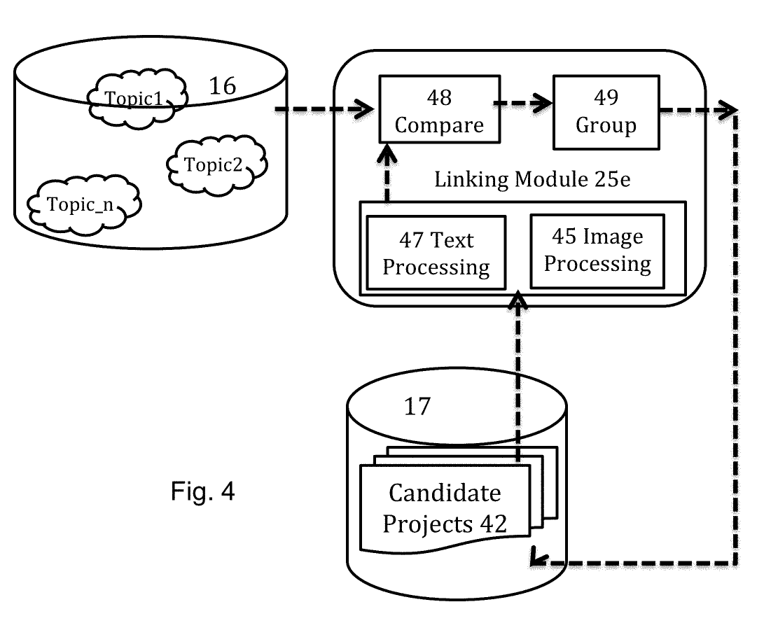

FIG. 4 illustrates how candidate projects 42 are linked using the Linking Module 25e. The candidates are sent for feature extraction by the Image and Text Processing Modules 45, 47. The extracted features may include metadata such as tags, dates and UUIDs of the connected nodes. The extracted features may be compared by Compare algorithm 48, preferably with the help of a Service Model 16 that has machine-learned to map and compute similarities of features. Certain of the candidate projects are deemed suitable for grouping by the Group Algorithm 49, as relating to the same or related projects. The relatedness is updated in the database 17, creating new super-project nodes or relatedness edges.

The Linking Module preferably separates attribute types and text portions of a project node into 1) project-identifying data, which identifies the project and 2) personalized data identifying a particular contribution or personal perspective of the project. The point is to identify a common project having many personal perspectives rather than a common perspective on different projects. Thus in certain embodiments, the Linking Module determines project identifying data using named-entity recognition to identify the name of the client, locations, product name, campaign project name, and Relation Extraction to identify relations between the entities (E.g. “Airbnb based out of San Francisco” . . . ). Other data such as background, temporal data, or results may be another source of project-identifying data to the extent that they are common to the project. The Module may use techniques such as NLP, named entity recognition, stemming, lemmatization and semantic similarity models to make allowances for misspellings, references to subsidiary companies, abbreviated names and synonyms.

The Linking Module compares the features and attributes of two candidate projects to calculate a likelihood of relatedness. Preferably attributes are weighted differently for each attribute type and text features are weighted by a technique such as TF-IDF. The Linking Module preferably requires that project-identifying data of two projects are similar in at least two features, unless there is a match in data that definitively identifies a unique project. For example, a client name is not definitive, as each client will have many projects; a project name is definitive; and a product name may be definitive if short-lived and infrequently referenced.

In certain embodiments, the Linking Module creates a model from the corpus of project nodes to model the frequency/commonness of features, tags and attributes. The model may determine a frequency statistic for each feature, tag or attribute value. The Module may calculate the likeliness of relatedness between projects proportional to the degree of feature matching, inverse to feature frequency, and proportional to the weight of an attribute type.

Alternatively, a clustering technique with feature engineering and text pre-processing may be used to cluster project nodes based on the features and attributes. The effect is to separate projects into clusters and provide a measure of the breadth of the cluster. Advantageously topic modeling is useful where project descriptions contain many overlapping words without an exact match in words for any two. For example, the project may not have had an official name or one that was commonly used by authors of different project documents. However, the authors may have provided paragraphs using similar vocabulary to describe the project. A topic model can determine that they are nonetheless related.

Thus, the system is able to automatically discriminate small, short-lived, infrequently referenced project terms from enduring, global, commonly referenced project terms. In the former case, all the projects are likely to be related and in the latter case, the projects are likely to be unrelated, separated into several project groups or only related at a superficial level.

Projects are not isolated nodes; they are connected in the database to users and organizations. Thus, the Linking Module also considers mutual connections to other nodes to identify likely related projects. The Linking module may traverse the graph to identify a common organization, typically where that organization is a client with respect to the project node. The Module may start from a given organization to identify all project nodes where services are provided to that organization, which projects are potentially related. This client/vendor nature is identifiable from the direction, label or nature of the edge connecting project and organization nodes, as defined by the database structure. Attributes of the client organization or of the edge form some of the project-identifying data used to calculate relatedness.

Once determined as highly probable or user-confirmed, the relatedness is recorded by creating an edge between the project nodes in the database. The edge may include a degree of relatedness or status to indicate whether the projects are duplicates, similar aspects of a project, different aspects of the same overall project or related projects of a super-project. The user confirmations/rejections may be used as training data to train the Linking Module.

A duplicate entry is a specific example of related project node, in which different users have entered data about the same aspect of the same project. For example, two coworkers on the project may independently enter project nodes. The Linking Module identifies project nodes where the vendor organization and client organization were the same, preferably for overlapping dates, and then compares features of the project nodes to calculate the likelihood of relatedness. Thus different users on behalf of the vendor and client may enter project data using similar images, attributes, tags and text, which are automatically linked by the system. The Module may link the duplicate nodes or delete one of the nodes to save storage. Preferably only one version of duplicate project nodes is displayed to a user.

The Linking Module may additionally compare attributes of organizations connected to possibly related project nodes to calculate the likelihood of relatedness. Normally the possibly related project nodes share some common graph patterns, such as being connected to a mutual client organization, whereby the other organizations are vendors supplying different products or services described in the respective project nodes. The Linking Module calculates likelihood based on similarity between these other organizations or services provided. Thus two organizations that provided similar or complementary services or products, at similar locations, during similar timelines are likely to have contributed towards related projects.

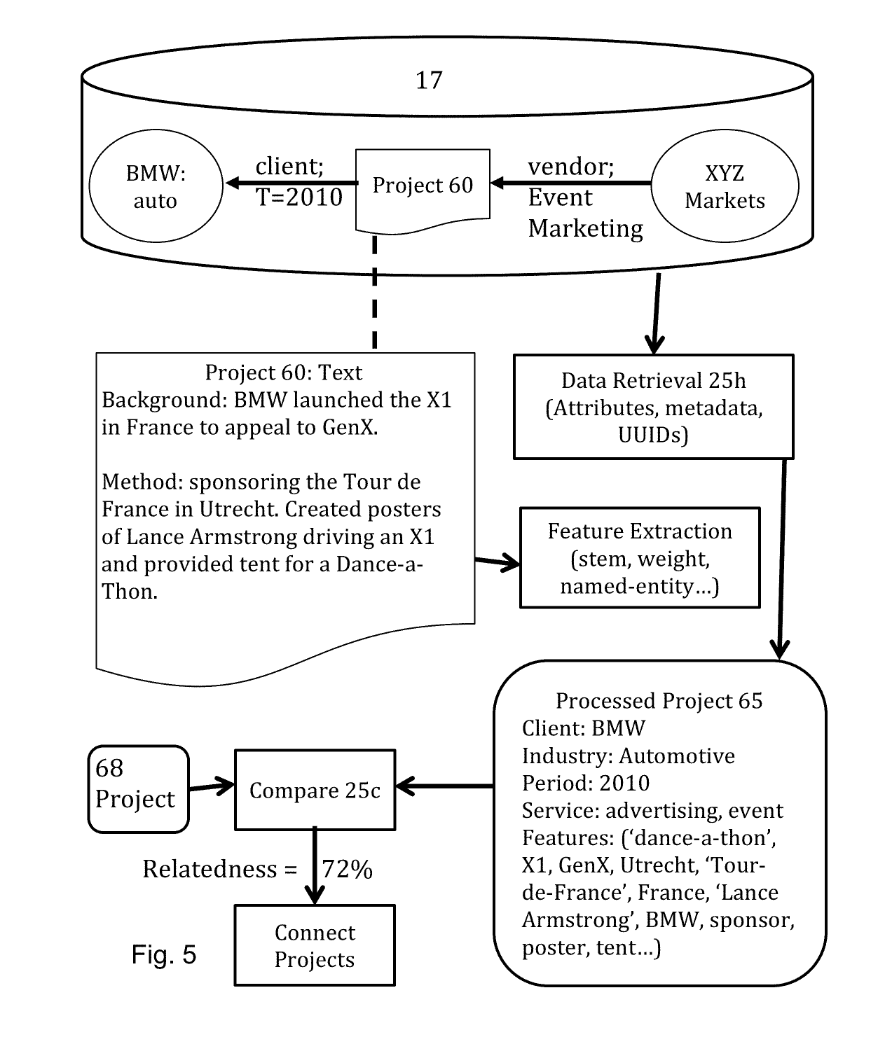

FIG. 5 illustrates a structured project document 60 having background and method aspects, which describe the client and their product aspects separately from the specific service and project aspects. In order to compare projects 60 and 68, the Data Retrieval Module 25h traverses the graph following outbound edges from each project to return data about the vendor, services, client, users, project attributes, and timelines. The Feature Extraction Module processes the project text to remove stop words, stem words, and identify named-entities, n-grams and structured tags. These identified project features are weighted using TF-IDF (but the weight values are not shown here). The processed case study 65 includes a feature vector and associated data of connected nodes. The Comparison Module 25c compares processed case studies 65 and 68 to output a likelihood of relatedness. If the likelihood is higher than a threshold, the system automatically creates a connection in the database between the case study nodes.

As project nodes are added, the features of each related project are combined to form a more complete definition of the project. From the combined features, the module can perform better modeling and make better predictions about other projects that are also related. Additionally, a Search Module may compare search parameters to the combined features to identify more relevant projects than comparing individual project nodes.

The group of related projects may have an anchor project node to act as a seed for grouping or reference point for graph traversal and similarity measures. The system may select, as the anchor, the first project created in the group, the project with the most data or project connected to the most nodes.

In certain embodiments, the Linking Module identifies a set of project documents as having a common client organization and displays them to that client organization to confirm relatedness. This rule assumes that the client is best positioned to know which outsourced projects were parts of the same project or super-project.

The Linking Module may also enable a user to append data to an existing project node without editing the original project or creating a new project. For example, a user may want to assert their contribution to a project, make a comment or apply a rating to it. Each user's detail about their contribution, comment text or rating may be appended to the project node in a field separate from the original project content. Alternatively, the Linking Module may store the added contribution, comment text or rating with the edge connecting the user and project node.

For fast access in future, the system may create a Relatedness table comprising pairs of project identifiers, where there is at least a threshold relatedness. The system may also create a Related Project adjacency list, comprising super project identifiers and respective lists of related projects. Thus, discovery and search results comprising any single project, easily leads to additional, related projects.

A representation of the project may be compiled in real-time by retrieving a plurality of project nodes connected to a requested project and displayed to a user. Preferably only one project perspective is displayed from a group of related project. More preferably the one project to display is selected by calculating relevance to the user-buyer or their search.

During search the search engine will find and rank all project nodes that satisfy the search parameters. Inter-project relatedness is identified from the indices. From each set of related projects, the single most search-relevant project is selected for display to the user. For example, a user may search for a project related to certain service, in a certain location, and for a certain industry. From a set of matching, related projects, the project that comprises metadata and description that best matches those search parameters is displayed.

The system may calculate a quality statistic for projects based on the number of users and organizations that connect to it and a quality score of those users and organizations. The statistic may apply to the project, as a single node or as a plurality of related nodes. Thus, as the quality statistic increases for the project, its relevance score improves in many methods such as discovery, recommendations, search results, and likelihood of relatedness.

The skilled person will appreciate that linking projects creates a fuller perspective of a project, increases trust in nodes within a group, reduces storage requirements, enables verification of business relationships, and focuses recommendation towards a coherent project group.

### Grouping Users into Teams

Many databases represent businesses as indivisible units and some store individual accounts even though they only work through their employer. Thus there are no database system that represent business-to-business relationships but also reflect the fact that it is specific people that work within those relationships.

In the present system, employees and organizations are stored separately but linked in the online professional social network. The system enables users to identify teams of employees, to represent B2B relationships with respect to relevant employees, and to discover the professional capabilities of organizations at the employee level.

In one use case, a buyer-user selects specific vendor employees or otherwise discovers them through machine-led discovery. The buyer-user groups a set of these employees via the present system for subsequent discussion with the vendor. This group may represent a team of people the buyer wants to work with for a project.

In a second use case, organizations group their employees into teams via the present web server to represent teams that work together on projects or that maintain a B2B relationship with another organization (via that other organization's own team).

These groups are digital, not physical or personal, representations of employees. They enable the present system via processors running instructions to determine group attributes, calculate group capabilities, and store data of employee nodes within that group.

Whereas existing business databases may retrieve records of a whole organization and score the organization's relevance to a query, and whereas personal databases may retrieve records of an individual and score the individual's relevance to a query, the present system may process data and calculate relevance of a group of individuals, i.e. less than the whole organization but more that an individual.

The present database and system may provide an online market for professional services. Buyer-users may discover or search for vendor organizations that provide a particular service. The system may query the database to identify and then display employees of the vendor that are relevant to those services. Alternatively the system may identify employees of the vendor that have been selected by the buyer. The attributes, capabilities, and data of the group of employees are displayed to the buyer users and/or vendor users. During online communications between users, these group attributes, capabilities, and data may be electronically shared to facilitate negotiations.

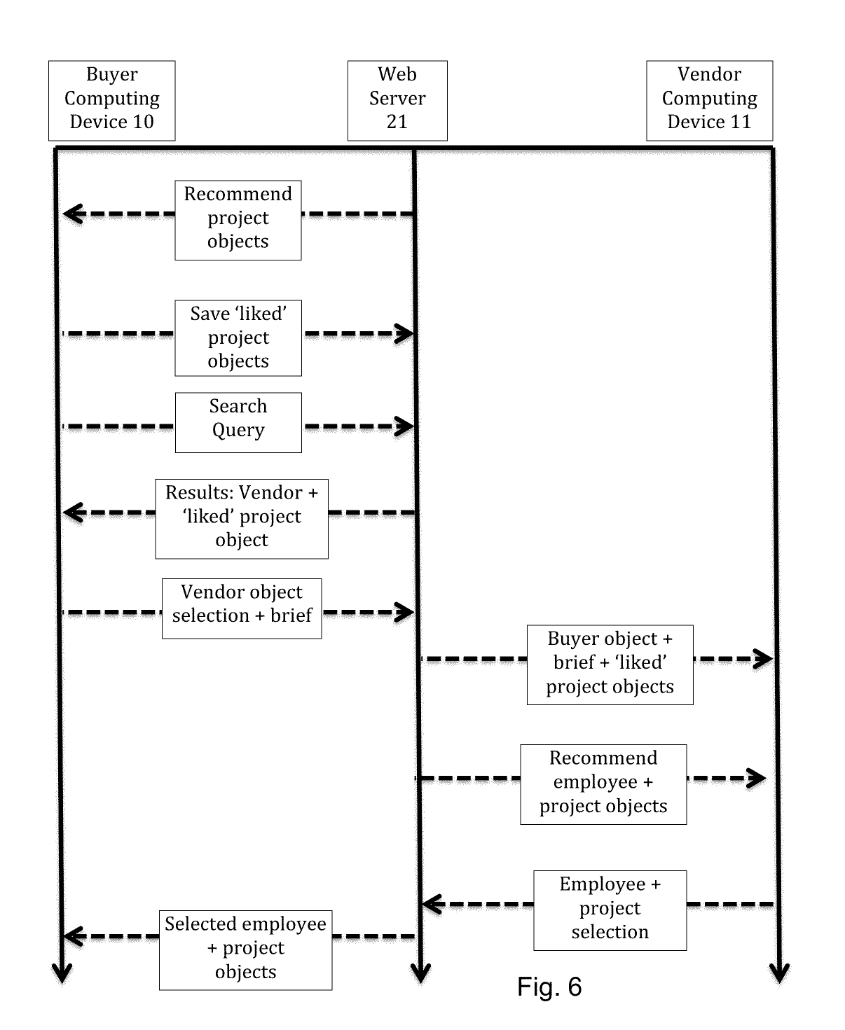

FIG. 6 illustrates data handling for buyer-seller communication. The web server 21 communicates a set of recommended project nodes. The Buyer via their computing device 10 indicates a selection of some of these projects as likes; the buyer computer send a search query for a vendor to the server; the buyer computer receives data of recommended vendors based on buyer likes in the database; the buyer computer submits a brief about the buyer project and a selection of vendors and employee or project nodes associated with the selected vendors; the server communicates to the vendor computer 11 the buyer's brief, the buyer's profile, and project nodes of that vendor that were selected by the buyer; the server evaluates and communicates to the vendor additional project nodes and employees nodes; the vendor computer 11 communicates to the server the vendor's selection of their employees and projects. Thus the system facilitates messaging between users by transmitting nodes that provide context for the conversation.

Each communication shown comprises an appropriate selection of data to identify nodes to the server or represent an node to a user, i.e. the whole node is not necessarily sent. These communications may represent the buyer signaling a preference to work with the like employees on a project like the like projects, and the vendor signaling that certain other employees or projects are more relevant.

### Latent Link Prediction

Advantageously the present system provides social networking virality, because each added project creates ‘hooks’ for more users and organization, either thru explicit user-selection or thru link prediction models. Although a new project node will initially have sparse connections in the graph, there are connection patterns to existing projects, users and organizations. Thus in preferred embodiments, the system employs a Link Prediction (LP) Module to predict which Users Ux or Organizations Ox also worked on project Py, preferably given that some User(s) Uy or Organization(s) Oy have already asserted credit for the project. The Module may calculate inferences from the existing network, teams of user, user job title/function, proximity with other users/organization. The result is a recommendation of one or more user-project pairs, between which a ‘credit’ edge will be created. That is, the system will create an edge of type ‘credit’ from a user to a project node, if a user accepts the recommendation.

Link Prediction techniques for future links in a social network have been discussed cs.cornell.edu/home/kleinber/link-pred.pdf. These techniques may be re-purposed to predict latent links between users and projects (or organizations and projects). Useful prediction models include: Graph Distance, Common Neighbors, Preferential Attachment, Adamic/Adar, Jaccard Coefficient, Katz, Hitting Time, Rooted PageRank, and SimRank.

Each of these models returns a LP score for user(s) in {Ux} asserting credit, given that one or more User(s) Y have asserted credit. Note that there does not need to be a prediction score for every pair of users in the social network; the system can limit its calculation to user pairs within a threshold number of hops. The prediction value is compared with respect to a threshold to determine which users should be recommended for receiving credit. That user or an admin user may be contacted to confirm/reject the recommendation. The user-user painwise link prediction may be calculated offline, with the LP scores stored in a matrix, which matrix is used when a given user enters a project.

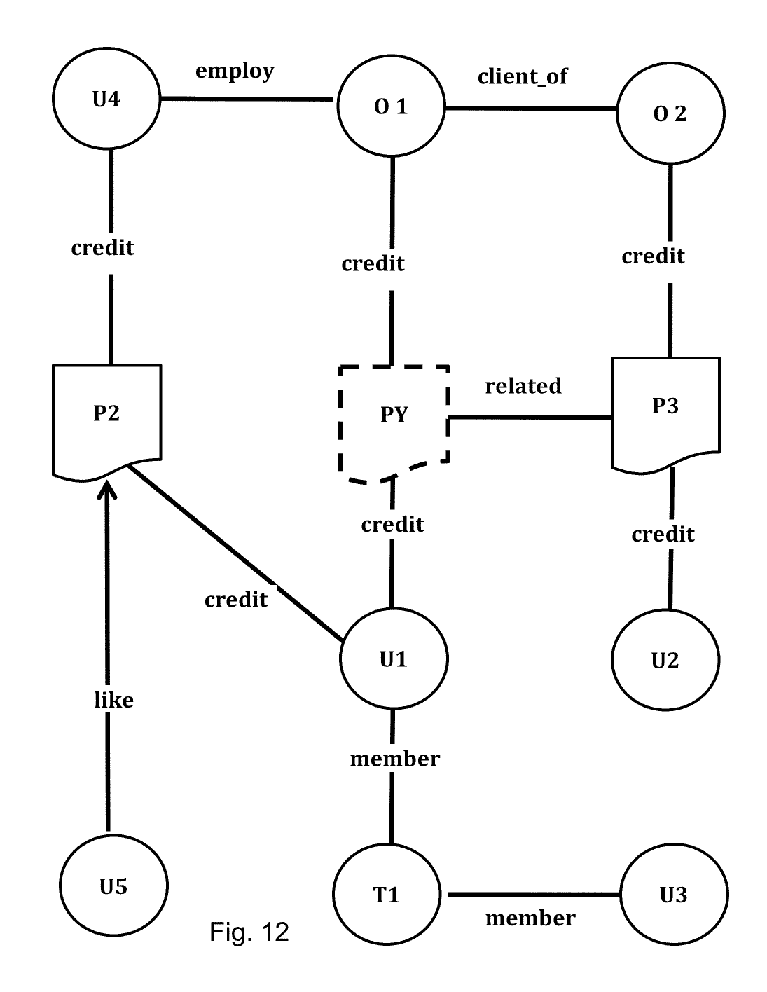

While the above listed techniques calculate the a priori, acontextual probability that any User x will work with a given User Y, improvement can be made by using a) other nodes in the graph such as team nodes, ‘related’ edges, other projects, and ‘employ’ edges and b) contextual information for the project. See FIG. 12 for examples of connections in a directed graph. O1 and U1 have recorded credit edges to Py and O2, U2-U5 are candidates for credit.

Team Nodes: a user (U3) is more likely to have worked on the project if they are connected via a Team node (T1) to users that have claimed credit for Py, as this fits the definition of a Team as used in the present system. Coworkers may be seen as a broader, more loosely defined set of users in a team. The ‘coworker’ edge may be set explicitly or inferred via a common employer organization.

Employ edge: users (e.g. U4) are more likely to have worked on the project if they are connected as employees of Organizations Y (e.g. O1).

Related edge: Projects (e.g. P3) that are related to Py are likely to have the same users and organization taking credit (e.g. O2, U2).

The LP Module may perform a Breadth First Search (BFS) starting from Project Py for a maximum number of hops (preferably 3 hops maximum) to find candidates {Ux}{Ox} that likely worked on that project. These hops operate on edges (or their inverses), such as ‘related,’ ‘employ,’ ‘coworker,’ ‘credit,’ ‘client_of’ and ‘member,’ passing through nodes, such as organizations, users, projects, and teams.

In FIG. 12, outbound edges are shown radiating from Py, in order to populate the sets {Ux} and {Ox}. The path traversal may be performed using a sequence of look-ups in indices for each edge type. In this example, there are paths from Py to U4 of length 2 and length 3 (the path of length 4 is ignored): Project Y-credit-Organization 1-employs-User 4; Project Y-credit-User 1-credit-Project 2-credit-User 4. Using select example equations:

GraphDistance=2

Katz=β¹×0+β²×1+β³×1=0.011 (for β=0.1)

CommonNeighbor=1

Jaccard=¼

PrefferentialAttahchment=6

Each user in {Ux} is evaluated using the algorithms above, preferably returning a LP score that increases with increased proximity between Ux and Py. For example, the LP score for the Graph Distance function could be 1/GraphDistance(Ux, Py).

A weighted LP score may be calculated by weighting edge types and node types traversed by each path or even excluding certain weak paths, such as Liking or Following (see U5), to capture the notion that certain connections are more indicative of working on projects. The Module excludes from consideration users already credited with working on Project Y (i.e. user nodes directly connected to the project node by a ‘credit’ edge).

A weighted LP score may also be calculated by calculating similarity/relevance of features of nodes in a traversed path with respect to the Project Py.

JobRelevance( ): the relevance of the user profile (e.g. job title, education, function, skills) may be computed with respect to the project node to provide a weight in the link prediction algorithm. The Module may use a machine learning model to derive an indirect mapping from features in a user node to project features, which can then provide a weight in the link prediction algorithm. The mapping is indirect in that project and profile features are not the same features, but rather, correlate in some machine learned way. In particular, the services used in the project may be compared to the skills of a user.

ProjectSimilarity( ): the features of project Py may be compared to features of other projects credited to a User X to weight Users X. The search engine may revisit each user {Ux} to identify projects {Px}. Each project may be represented by a vector of features or topics, from which a dot product or F-diverge computation may be made, with respect to the feature or topic vector of Py. A user may have credit for multiple projects, in which case the user's project relevance score may be the sum of each project similarity score.

Overlap( ): The employment data and project data may include temporal data, preferably as a range of dates. An Overlap (Ux, Py) function may be used to calculate the percent of the project date range that Ux worked at an organization that is connected Py (e.g. nodes O1, U4, and Py in FIG. 12). An Overlap score of zero indicating that Ux did not work for Oy during the time of project and a score of 1 indicating that Ux worked for Oy during the whole time of Py (and perhaps longer).

The user's past project similarity, job relevance, date overlap, and graph proximity may be combined to compute a weighted link prediction score, Weight LP. For example,

$$WeightLP = \frac{\begin{matrix}Overlap ( Ux , Py ) \times ProjectSimilarity ( Ux , Py ) \times \\ JobRelevance ( Ux , Py )\end{matrix}}{GraphDist ( Ux , Py )}$$

The (weighted) LP Scores are used to rank the candidates {Ux} and/or compared to a threshold to select the most likely set {U′x} of users that worked on the project, and for which a ‘credit’ edge should be created if accepted by that user (or another user, such as an admin user).

Similarly, candidate Organizations {Ox} may be identified using BFS and evaluated using a weighted LP score to suggest the most likely set {O′x} of organizations that worked on the project, and for which a ‘credit’ edge should be created, if accepted by an admin user.

### Discovery and Recommendation

A social network with extensively connected users and projects enables the system to provide recommendations of projects and organizations that could not be based on the attribute data alone nor based on a user's explicit search query alone. In particular, a graph facilitates this with great computational efficiency. The system enables users to discover project/user nodes, select nodes, and receive recommendations based on the selected nodes. For example, collaborative filtering techniques may be used to help the user discover projects/users that are similar to projects/users already ‘Liked’ or ‘Followed.’

In one use case, the system provides means for a user to collect, shortlist, like or otherwise save nodes from a database for subsequent use, preferably saved as a group of nodes (hereafter ‘liked’ nodes). A client-computing device receives a plurality of nodes, representing past projects, people, or organizations. A user views the nodes via the client-computing device and selects one or more nodes to be saved. Typically, this grouping action is done via a website in which nodes are displayed beside a button. When items are selected, the system connects corresponding nodes to the user via ‘like’ edges or stores the nodes' IDs in a ‘like’ list. The list or edge node may include a name identifying the group, distinct from another group of that user.

Various known explore/exploit techniques, such as Multi Armed Bandit (MAB), may be used to select nodes that are likely to be ‘Liked’ by a user based on prior knowledge (exploit) and less obvious nodes that help the system understand the user (explore). These nodes are shown to the user for selection.

For example, a user may select a set of ‘liked’ images, videos, awards, past projects and documents {P_{L}} to be grouped as inspiring examples of a service or a set of ‘liked’ people {U_{L}}. In FIG. 2, user U1 saves Image1 and Image2 into ‘liked’ List A, this connection being different from the connection to Image 3 to which they have a ‘credit’ edge. The grouping function enables the system to process scores and data more efficiently at a subsequent time. This grouping does not correspond to relatedness of projects discussed above.

This grouping of a set of items has a meaning for the respective user, rather than a global implication. However, in certain embodiments, the system provides means for a first user to share a ‘liked’ node or list with other users within the social network. The other users benefit from the first user's selection efforts. Via the UI, the first user selects a pre-created group and a second user. The system electronically communicates the group (as a list of node IDs or a set of links to the nodes) to the second user, enabling them to view and/or create an edge to those nodes or list.

This ‘like’ connection may assist in online marketplace functions. A buyer-user may select one or more vendors to provide a service. The search engine identifies nodes connected to the vendor (such as users via an ‘employ” edge employees and projects via a ‘credit’ edge) that are also connected to the buyer-user via a ‘liked’ edge. The projects connection to the buyer-user may be an implied connection simply because the user viewed an item, or it may be an explicitly, previously ‘liked’ connection.

The server 12 communicates to the vendor organization their own nodes ‘liked’ by the buyer-user, which is viewed by a vendor-user associated with the vendor node. The vendor-user continues marketplace activities with the buyer-user within the context of the ‘liked’ nodes.

In certain embodiments, a search engine scores vendor organizations for the purpose of providing search results and push recommendations. The server may receive a search query entered by a buyer-user via a website or app running on a client-computer 10, 11. An inferred query may be created by the system from a plurality of attributes (such as locations, service, size, or experience) that the system determines from past user searches, past user interaction with nodes, or likely desirable attributes of vendors based on collaborative filter algorithms from users similar to the present user. Therefore the system generates a search query based on what the user has searched for or likely would search for.

The processor performs a database query to find the vendor node that best satisfy the query attributes. The system retrieves ‘like’ nodes of the buyer user or buyer organization. The engine identifies any connections between the ‘liked’ node and vendors. That is, for each vendor, the search engine determines the intersection of buyer ‘liked’ nodes and nodes credited to that vendor. Preferably the vendor is connected via a credit edge to a the ‘liked’ project node (indicating that the vendor worked in that project) or via an ‘employ’ edge to a ‘liked’ user. The system calculates a score for each query-satisfying vendor based on the number of ‘liked’ nodes connected with that vendor. In FIG. 2, buyer-user U4 has a like video node on List B. The video node is also connected by a ‘credit’ edge to Vendor V2, making this a high-scoring vendor (assuming V2 also satisfies the query).

The system may analyze the ‘liked’ node using a service model, image processing, or text processing techniques to calculate a relevance score of the node to the search query. The vendor score may be based on the number of ‘liked’ nodes, weighted by the relevance score of each node. The highest scoring vendors are communicated to the buyer user as search results or push recommendations.

Preferably only one project representation is communicated when there is a group of related, relevant projects. This may be a single project exemplar or a combination of items that represent the project grouping. For example, an image from one project may be combined with the text of another to display to the user. Preferably the system, via the UI, enables the user to select a project group to view more data within that group.

The system may also traverse the relatedness graph to identify other project nodes that are related to a project that has been ‘liked’ by a given user.

### User Intersection

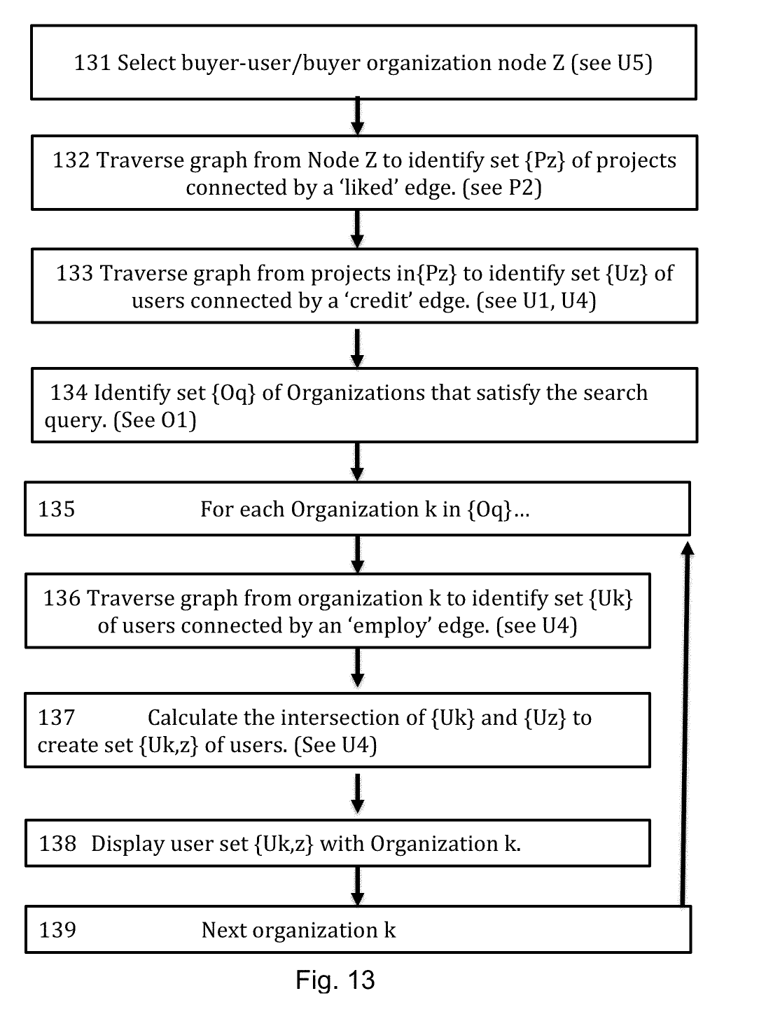

The structuring of the database to enable a ‘like’ edge between a user and a project, not only project context when viewing an organization profile but also user context. That is, an organization may be ranked by or displayed with employees of that organization that are implicitly liked by the user. FIG. 13 provides a flow chart for identifying the intersections of users that are both employees of a given organization AND credited with working on a project liked by a user. Thus three edges and three node types are examined in the graph traversal.

As shown, the system identifies the node z corresponding to the user or organization for which a display of organization is sought (131). The system traverses the graph from node z via ‘like’ edges to identify a set {Pz} of projects (132). The traversal continues via ‘credit’ edges to identify a set {Uz} of users (133). Separately the search engine identifies organization {Oq} that satisfy a query.

The skilled person will appreciate that the graph traversal and set calculations may be varied from that shown in the flowchart. For example, the system may identify satisfying organizations, then their employee-users, then projects credited to those users, and finally identify those projects also ‘liked’ by the searching user.

The graph is a mathematical model of connections between entities. The skilled person will appreciate that the graph may be implemented using indexes, inverse indexes, adjacency matrices, feature look-ups tables and other data structures. The selection of such structures will depend on what searches are to be supported and how the graph is normally traversed. Thus, while an index might return all nodes connected immediately to a given node, it may be more informative for certain searches to create an index that return all user nodes within two hops. The latter removes the need for real-time graph traversal by particular edge types, removal of duplicates and non-user nodes, and aggregation of their features.

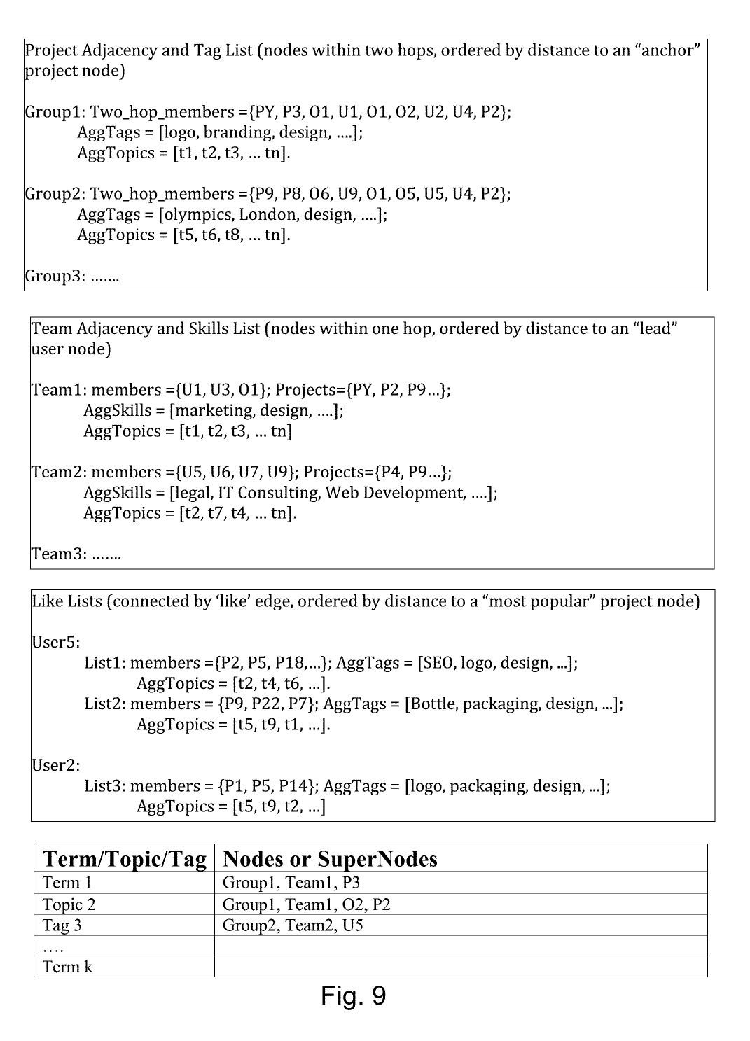

FIG. 9 shows a set of example lists for rapidly returning grouped nodes, their tags, and their features, based partly on the subgraph of FIG. 12. The first document is a pre-computed adjacency list with aggregated tags and topics to represent a group of related projects. The system has identified all unique organization, user and project nodes within two hops of an anchor project node, where the hops were limited to certain edge types (here, excluding liked′). The node identifiers may be ordered by graph distance from the anchor project to prioritize processing of nodes in real-time. The system retrieves features, such as tags applied to the node or terms/topics extracted from the node document, and then aggregates them to create tag and topic/term vectors that collectively represent the group.

Thus, given a group identifier, the system quickly identifies which users and organizations worked on the set of related projects and what tags/terms/topics best describe them. Inversely, the fourth index in FIG. 9 enables a project group to be discovered, given a term/topic/tag in the search query. This reduces the need to list every node for a term/topic/tag, notwithstanding that the individual member nodes could be listed too.

Similarly. FIG. 9 illustrates a team list for identifying user members of a team and their aggregated featured (tags/skills/topics/terms). The third document provides a list of ‘liked’ projects for each user, separated into different lists. Again, the system aggregates features (tags/topics/terms) of the listed projects.

### Aggregating Employee Skills

Existing business databases and search engines rely on data entered by the organization or taken from online sources. The data is hard to verify and the weight of a given value hard to estimate. Consider known databases that record multiple addresses, services, and experience data as attributes for a given organization. Such a system cannot determine how many people, at a given office, provide a given service nor quantify how strong that service offering is. These attributes are typically stored as simple values for each attribute type. These simple values are not derived from raw data nor are the values dynamically updated. The database also becomes incorrect when an employee moves company or office within a company. On existing databases, the attribute values for the companies do not change. However, existing search engines use these unverified, out-of-date values to calculate search results.

A further advantage of creating a social-business graph is that an organization's expertise and relevance to certain search criteria may be derived from their employees' experiences and the organization's claimed expertise is also known from more granular evidence than a mere binary tag. Thus in the present system, the database structure comprises organization nodes connected to user nodes (by an ‘employ’ edge to denote employees) or project nodes (by a ‘credit’ edge), wherein the user and project nodes contain text/tags relevant professional services. The organization nodes may also contain data describing professional services but now these can be derived and quantified from the data of the connected employees and project.

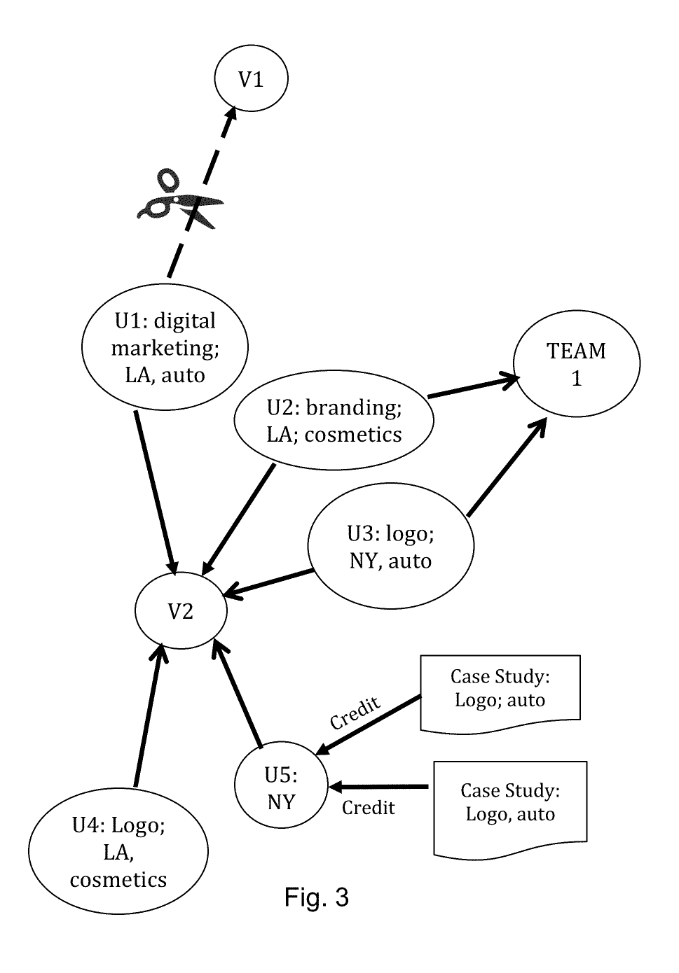

From the graph shown in FIG. 3, the present system can deduce that Vendor V2 provides digital marketing services and logo design (because their employees do) and can quantify these services as: three logo designers, two digital marketers. Likewise, the system can deduce and quantify other attributes, such as office locations (NY=2, LA=3, etc.) and industrial experience (cosmetics=2, auto=3). The system can even identify complex attributes such as that they provide digital marketing for cosmetics in LA. Such inferred attributes, complex attributes, quantities may be useful in locating and ranking organizations for search results.

The system retrieves attributes and features for each user employed by and project credited to an organization. These attributes and features are combined to calculate aggregated attributes and features, towards the organization. The feature data may be stored as a vector of features for each user and project node, preferably weighted as a Probability Mass Function (PMF), whereby the organization's vector is the sum of vectors for the connected nodes. This feature vector preferably comprises features relevant to the parameters available for searching; e.g. if industry is a search parameter then the feature vector should include a plurality of industry values). A user node's feature vector may itself be inferred from feature vectors of project nodes connected to the user as a contributor. In FIG. 3, employee U5 is credited with two case studies regarding logo designs for automotive clients and is thus inferred to provide logo services and have auto industry experience, which in turn are attributed towards the vendor V2. In any of the project, user, and organization nodes, the feature vector includes a non-zero value for ‘logo service’ and “auto industry.”

Thus the data structure efficiently stores attributes as evidence, which can be past to connected nodes thru inference determined by an Aggregation Module.

The Aggregation Module may employ a simple linear algorithm, whereby the calculated strength of a feature for an organization increases with the number of their employees or projects having that feature. Alternatively, the Module's output for a given feature may be binary, depending on whether or not the organization is connected to employees or project nodes having that feature. Alternatively, the Module employs a sub-linear or diminishing returns approach, such that additional employees or projects increase the strength of a feature value by progressively less amounts.

Projects and user profiles are normally written to describe the project's story or user's skills/education, which is easy for human consumption, but does not provide direct, automated information retrieval with respect to certain features of an organization (such as services). In certain embodiments, the Aggregation Module first processes each user or project node to extract features and then map them to search-relevant values using a semantic Service Model, which values populate the feature vector. Thus organizations connected in the graph as employers of users with relevant skills or as credited with relevant projects will be relevant with respect to a given service that is searched, which is used in ranking search results of organizations.

The Service Model may use machine learning to learn an indirect mapping of user and project features to services. For example, the machine learning may use the skills, education and job titles of a training set of users that are tagged with one or more services that they can perform. Similarly, a training set of projects comprising descriptive text may be tagged with services involved. From these training sets, the machine learning forms the Service Model to map subsequent user and project features into services they can likely perform, which services are then inherited by the employing organization. The machine learning may use a neural net. The feature vector values may be scalars representing a calculated probability of performing respective services.

The system may also use the user or project feature vector on its own, for example to rank or recommend user or projects themselves in search results. In one use case, the system ranks user and project relevance with regards to certain parts of the search query in order to output the users and projects with the respective organization. Other factors may also affect the ranking, such as social connections between the employees and the buyer's employees. The system selects a subset of the highest-ranking users to display to a searcher, as an indication that these employees of a matching organization are most relevant to the search criteria.

The system is arranged to permit changes in connections between nodes, which enables the processor to dynamically update the inherited organization features and provide better search results and recommendations. The changes may be employment changes or new credit for projects, which are realized by deleting and/or creating ‘employ’ and ‘credit’ edges in the graph. The system may receive a request via the User Interface to update an employment connection from a first organization to a second, for a given user. The system deletes the ‘employ’ edge from the user to the first organization node and creates a new ‘employ’ edge to the second organization node. The system recalculates the feature vector for both organizations—reducing values of the first and increasing values of the second. The result may even be to add new or completely remove services for the organizations.

Thus the system is able to transfer the experience of an employee from her old employer to her new employer. In FIG. 3, employee U1 previously work for vendor V1, gaining certain experience, tags, and features. She moves and so her experience no longer counts towards V1 but does count towards V2, even though she has just joined them.

As discussed elsewhere, a user may create or connect to project nodes in the database, whereby the ‘credit’ edge indicates a contribution by the user. When a user successfully obtains new credit for contribution to a project, the system may dynamically update the feature vector of the user, which in turn updates the feature vector of the employer organization. Thus the system may create a new ‘credit’ edge between a user and a project, which project is tagged for a particular industry and the contribution is tagged for a particular service. The system can update the user node to indicate that the user provides that service to that industry.

### Faceted Search Results

The above methods and data structures may be used in conjunction with a search engine that matches a query to primary nodes, which are then ranked and displayed. The search engine retrieves a search query from a User Interface, the query comprising a plurality of search features (such as location, tags, services, skills, terms, topics, size, industry, etc.). The search engine may apply the query to both the primary nodes to be returned as search results as well as to nodes connected to those nodes. For example, the search engine may identify organizations (the primary node) that satisfy certain firmographic features of the search query, which organizations are connected to projects and users that match certain other features of the search query. The primary nodes may be scored and ranked based on both primary node matching and connected node matching algorithms.

One problem that arises when so many nodes are relevant to the search and to each other, is the likelihood of returning duplicates in the search results. Several related projects may be identified as the top matching projects with respect to the search, assuming they all contain the features used in the query. Thus, the system uses the above-described data structures to identify duplicate projects and determine which one to display to the searching user, as a facet of the search results.

The search engine identifies sets of related nodes, such as groups of related projects or teams of users, where either the set of nodes or individual nodes of the set satisfy a part of the search query. In preferred embodiments, at least one member of a set is communicated to the user in conjunction with the primary node in the search results. For example, the search results displayed may be an organization (as primary node) proximate one project and one user. The search engine ranks the members of the set based on their relevance to the search query.

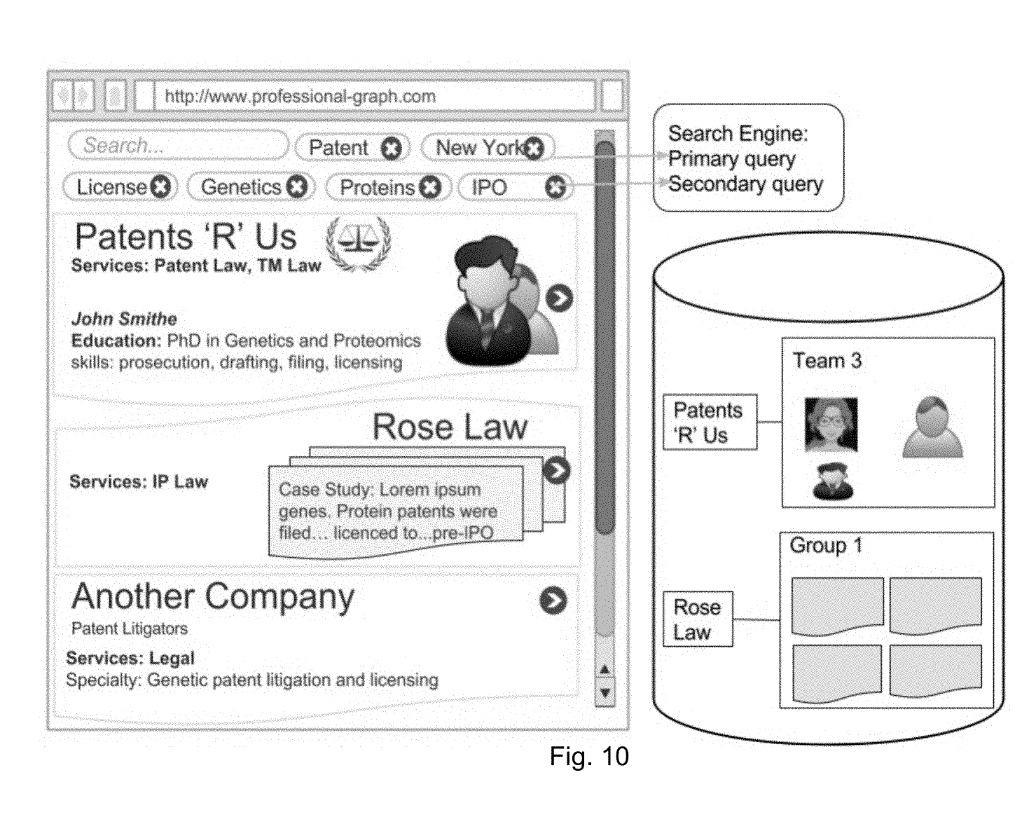

FIG. 10 provides an example UI comprising a plurality of features of a search query and, below it, a set of search results. The search engine ranks primary node (organizations). These organization results are supported by a group of projects or a team of people. Rather than show all members, the search engine selects one project and person to highlight for the organizations, where that project or person is most relevant to the search results. Here, “John Smithe's” profile comprise features relevant to ‘patent’ ‘genetics’ ‘proteins’ and ‘license’ (where the topic model or service model has mapped the search terms to the similar features in the profile). The remaining people profiles are ranked as less relevant but still viewable. Similarly, the related projects are ranked by relevance to the search, where the project selected to display describes the project using terms relevant to the search (the other project descriptions might provide different perspectives of that project group).

### Verifying Relationships Via Projects

An advantage of structuring the database as described herein is that business relationships are verified without requiring an explicit acceptance of a request, which is common for existing social networks. In particular, the creation of project nodes and their connections to organizations (directly or indirectly via employees) enables the present system to verify that there is a business relationship between the organizations.

In FIG. 2, employee U3, employed by Client C2 adds a project node to the database. User U2, employed by Vendor V1, claims credit too. U3 has administrator rights and connects C2 to the project node by a ‘client’ edge. The same occurs for V1. No client-vendor relationship needs to be asserted by either organization C2, V1. The system processes the edge data to infer that a relationship between V1 and C2 exists. Inductively this business relationship is determined and stored in the database and marked as ‘verified’ or given an increased verification score.

Other relationships may be inferred or verified by the system, using a project as a connection mechanism. For example, the system may determine a probability that users U2 and U3 know each other, given that they worked on the same project. Similarly, if the employment relationships shown in FIG. 2 were not known, the system may infer it, assuming that each user worked for one of the connected organizations and that each user has profile attributes that are more similar to the attributes of one of the organizations that the other. The system thus creates an inferred ‘employ’ connection between a user and the more similar organization node.

Over time the web server receives 1) a request from a first user employed by a first organization to connect nodes of the first organization and a given project and 2) a request from a second user employed by a second organization to connect nodes of the second organization and the same, given project. The requests preferably indicate that a first organization supplied goods or services to the given project and separately that the second organization received goods or services from the given project. In response to such requests, the processor infers a connection between the first and second organizations. If such a connection already existed, the system calculates and records a verification score with the edge (e.g. the business relationship edge). Otherwise a new business relationship edge is created in the database between the organizations. As more mutual connections are made from first and second organization to project nodes, the verification score increases.

Alternately the system infers which organization provided or received goods/services based on 1) the attributes of the organizations and of the project or 2) the attributes of other projects connected to the organizations' connections. Therefore, organizations that are recorded as providers of a particular service are inferred also to be providers to a project that requires similar services.

A similar inference algorithm is applied to requests to connect users to projects, such that employment or social connections are inferred to exist.

Advantageously, a system is provided that encourages users to share projects and be recognized for their contribution, which has the side effect of implying other relationships exist and are verified.

1. A computer-implemented method for operating on a graph database having organization nodes and project nodes, the method comprising:
for each of a plurality of organization nodes in the database;
traversing the graph to identify project nodes connected to that organization node;
retrieving project features for the identified project nodes;
aggregating the project features to create a set of organization features for that organization; and
in response to a search query comprising search features, returning organization nodes having organization features that match the search features.

2. The method of claim 1, further comprising providing a service model to map organization features to service features and calculate a confidence score for each service feature so mapped.

3. The method of claim 1, wherein the project node comprises text and tags that describe a past project done by the organization connected thereto in the graph.

4. The method of claim 1, wherein the project data relates to an award, a case study, news article, or sample work.

5. The method of claim 1, wherein the service features comprise n-grams and tags describing professional services and capabilities.

6. The method of claim 1, further comprising creating the service model using machine learning, trained on a set of project nodes tagged with service features.

7. The method of claim 1, further comprising applying a decay factor to project features, using dates of the respective project node, to calculate the aggregated organization features.

8. The method of claim 1, wherein the organization features are aggregated using the union of the project features.

9. The method of claim 1, further comprising, for each organization node, calculating strength values for each of the organization features based on the frequency of project features in the project nodes.

10. A computer-implemented method for operating on a graph database having organization nodes and user nodes, the method comprising:
for each of a plurality of organization nodes in the database;
traversing the graph to identify user nodes connected to that organization node by an employment edge;
retrieving user features for the identified user nodes;
aggregating the user features to create a set of organization features for that organization; and
in response to a search query comprising search features, returning organization nodes having organization features that match the search features.

11. The method of claim 10, further comprising providing a service model to map organization or user features to service features and calculate a confidence score for each service feature so mapped.

12. The method of claim 10, wherein the user node comprises text and tags that describe a skills, education, and jobs of the respective user.

13. The method of claim 10, further comprising creating the service model using machine learning, trained on a set of user nodes tagged with service features.

14. The method of claim 10, wherein the organization features are aggregated using the union of the user features.

15. The method of claim 10, further comprising, for each organization node, calculating strength values for each of the organization features based on the frequency of user features in the user nodes.

16. The method of claim 10, further comprising re-aggregating organization features for a particular organization node, when an employment edge is removed or added between a particular user node and that organization node.
